(19) United States
(12) Patent Application Publication
(10) Pub. No.: US 2022/0284448 A1
(43) Pub. Date: Sep. 8, 2022

(54) ANTI-COUNTERFEITING AND ENCRYPTION METHOD BASED ON LOCAL RANDOM IMAGE TRANSFORMATION TECHNIQUE

(71) Applicants: TONG, Qinye, Hangzhou (CN); TONG, Wenge, Shanghai (CN); TONG, Wenji, Shanghai (CN)

(72) Inventors: Qinye TONG, Hangzhou (CN); Wenge TONG, Shanghai (CN); Wenji TONG, Shanghai (CN)

(21) Appl. No.: 17/826,207

(22) Filed: May 27, 2022

Related U.S. Application Data
(63) Continuation of application No. PCT/CN2020/131659, filed on Nov. 26, 2020.

(30) Foreign Application Priority Data
Nov. 29, 2019 (CN) 201911203213.3

(51) Int. Cl. G06Q 30/00; G06T 11/20; H04L 9/08; G06V 10/75

(52) U.S. Cl. CPC G06Q 30/0185; G06T 11/206; H04L 9/0869; G06V 10/758

(57) ABSTRACT

Disclosed is an anti-counterfeiting and encryption method based on a local random image transformation technique, which belongs to the technical field of anti-counterfeiting and encryption. In the present disclosure, local replacement is performed on random images (that is, the arrangement structure of pixels in a space is changed or pixel values are changed), and then, two random images are used to store corresponding information; and “locally scrambled” portions of the images contain a part of key information. However, since the images are still random, there is still no explicit information display in the images; and even if the information is intercepted during a transfer process, the content of the information cannot be known without the original first random scatter plot, and the existing information also cannot be tampered with. In the present disclosure, a user does not need to memorize any password.

### CROSS-REFERENCE TO RELATED APPLICATIONS

The present application is a continuation of International Application No. PCT/CN2020/131659, filed on Nov. 26, 2020, which claims priority to Chinese Application No. 201911203213.3, filed on Nov. 29, 2019, the contents of both of which are incorporated herein by reference in their entireties.

### TECHNICAL FIELD

The present disclosure belongs to the technical field of anti-counterfeiting and encryption, in particular to an anti-counterfeiting and encryption method based on a local random image transformation technique.

### BACKGROUND

The biggest advantage of digital technology is its high stability. It can realize transmission, copying and storage without loss. This is the biggest advantage, but it also brings great difficulties, and its security problem is really difficult to solve.

Bitcoin anti-counterfeiting technology can be regarded as the safest means. Actually, it uses the encryption technology of RSA or ECC instead of anti-counterfeiting. Since the public passwords RSA and ECC have not been deciphered at present, Bitcoin has become the safest means. Although RSA and ECC have not been deciphered, they can be deciphered by an exhaustive method. To improve the reliability of RSA and ECC, its reliability can only be increased by increasing the number of calculated bits. Now RSA has increased to 1,000 to 2,000 bits. The personal computer that is usually used is of 64-bit double precision, so it is really inconvenient to use this computer to calculate 1000 digits. Although the number of ECC bits is only 200-300, because of its high computational complexity, it is also equivalent to 1000-bit RSA encryption intensity but this method also has problems and takes a long time. Especially on mobile phones, it's difficult and almost impossible. Recently, the blockchain is very hot. In fact, the core part of blockchain also contains public passwords, so it also has the same weaknesses as RSA and ECC. Therefore, these are basically not used in e-commerce.

Nowadays, e-commerce (e.g., e-invoice, Alipay, etc.) uses a string composed of general random numbers and phonetic alphabets as random passwords. To increase confidentiality, numbers, character codes and the like are added as authentication identification codes; in addition, these strings are used to transmit information through different channels (such as telephone messages, WeChat, Email, etc.); there are also methods such as confirming the phone numbers. Various means are combined for encryption and anti-counterfeiting. But these methods are not very safe.

With the development of network application, e-commerce, e-management and e-service, the problem of network security becomes more and more prominent. Encryption and anti-counterfeiting technology are becoming more and more necessary technologies.

### SUMMARY

The application aims at solving the defects of security and reliability of anti-counterfeiting and encryption methods in the prior art, and provides an anti-counterfeiting and encryption method based on a local image scrambling technique.

The specific technical solution adopted by the application is as follows:

In the first aspect, the application provides an anti-counterfeiting and encryption method based on a local random image transformation technique. Both a sender and a receiver of encrypted information have a same first random scatter plot; the anti-counterfeiting and encryption method includes the following steps:

S1, forming, by the sender, a corresponding local coverage area on the first random scatter plot with a pattern of information to be encrypted, and carrying out pixel value transformation on all pixels or some randomly dispersed pixels in the local coverage area on the first random scatter plot to obtain a second random scatter plot.

S2, after receiving a unique identification code of the first random scatter plot and the second random scatter plot, calling, by the receiver, the first random scatter plot stored by the receiver according to the unique identification code, comparing the first random scatter plot with the received second random scatter plot point by point, and subjecting the pixels in the second random scatter plot whose pixel values are inconsistent with those in the first random scatter plot to display processing to obtain displayed encrypted information.

The random scatter plot in the present disclosure refers to an image whose pixel values have no regularity in space. As the existing random number generation algorithms are also regular in nature, it is not easy to be completely random, therefore random numbers shall not be used by such algorithms as much as possible.

As the preference of the first aspect, a method for the pixel value transformation adopts a spatial scrambling method, and the spatial scrambling method includes the following steps: selecting all pixels or some randomly dispersed pixels in the local coverage area, and performing spatial position exchange, so that an image after spatial scrambling is still a random scatter plot.

Further, in the spatial scrambling method, when the spatial positions of pixels are exchanged, only the spatial positions rather than pixel values are changed; after receiving the unique identification code of the first random scatter plot sent by the sender, the receiver calls the first random scatter plot stored by itself according to the unique identification code, compares each pixel in the first random scatter plot with the received second random scatter plot, and determines whether there is any pixel whose pixel value has been changed in addition to exchange of the space position; if not, anti-counterfeiting authentication passes, otherwise the anti-counterfeiting authentication does not pass.

As the preference of the first aspect, the method for the pixel value transformation adopts a numerical value replacement method, and the numerical value replacement method includes the following steps: selecting all pixels or some randomly dispersed pixels in the local coverage area, and replacing the pixel values thereof directly by other random values, and the image after numerical value replacement is still a random scatter plot.

As a further preference of the above preferred modes, when selecting randomly dispersed part of pixels in the local coverage area, a selection ratio should be configured such that the information can be read after the part of pixels are subjected to display processing.

As the preference of the first aspect, the information to be encrypted is characters or patterns with information.

As the preference of the first aspect, there are a plurality of first random scatter plots, and each of the first random scatter plots has a unique identification code; the receiver stores a gallery containing the plurality of first random scatter plots; before each pixel value transformation, several first random scatter plots are randomly selected to perform a mathematical operation according to a predetermined rule, and a new first random scatter plot is generated to perform the pixel value transformation; and the unique identification code of the first random scatter plot participating in the mathematical operation and the predetermined rule are sent to the receiver.

As the preference of the first aspect, the display processing is color display or display in other methods.

As the preference of the first aspect, the image is a black-and-white image or a color image.

As the preference of the first aspect, the pixel value of the image is 8 bits, 24 bits or other bits.

Compared with the prior art, the application has the following beneficial effects:

1) The existing methods mainly use numbers, symbol codes, etc. to encrypt, and such information is all information without space-time structures. However, the application uses an image with a spatial structure to store encrypted information, which can greatly improve the security of encryption. Encryption and anti-counterfeiting by using spatial structure characteristics is the biggest feature of the application.

2) The random image is locally replaced (that is, the arrangement structure of pixels in space or the pixel value is changed), and then two random images are used to store the corresponding information. The “locally scrambled” part of the image contains the key information, but because it is still random, there is still no explicit information display in the image. Even if the information is intercepted in the transmission process, it is impossible to know the content without the original first random scatter plot, and the existing information cannot be tampered with.

4) The user does not need to memorize any password, which is convenient to operate and simple to operate, and is suitable for mobile terminals such as mobile phones.

5) The application has the advantages of simple operation, high speed and convenient use in mobile devices, and can be used as a supplement to blockchain.

6) The information to be encrypted can be input by handwriting, keyboard, QR code or other systems. If it is used in the existing mobile payment client (for embodiment, Alipay, WeChat payment, etc.), it can be used almost without changing the interface (the noise figure does not need to be displayed), and it can also reduce the process of authentication by a few steps. Of course, in the actual operation process, signatures can be added as needed.

### BRIEF DESCRIPTION OF DRAWINGS

FIG. 1 is a schematic image of a first random scatter plot;

FIG. 2 is a schematic image of a first random scatter plot with a local coverage area;

FIG. 3 is a schematic image of a second random scatter plot.

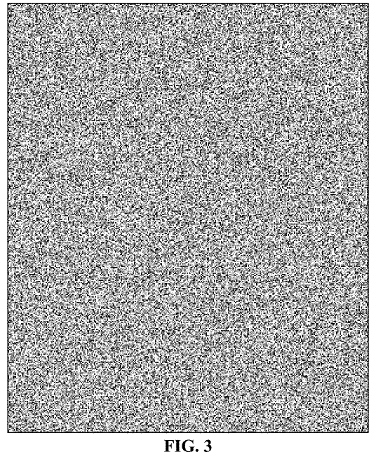

### DESCRIPTION OF EMBODIMENTS

The present disclosure will be further illustrated and explained with reference to the drawings and specific embodiments below.

### Embodiment 1

In the embodiment, an anti-counterfeiting and encryption method based on a local random image transformation technique is provided, in which a sender and a receiver of encrypted information have the same first random scatter plot. There can be one or more first random scatter plot. The steps of the anti-counterfeiting and encryption method are described in detail as follows:

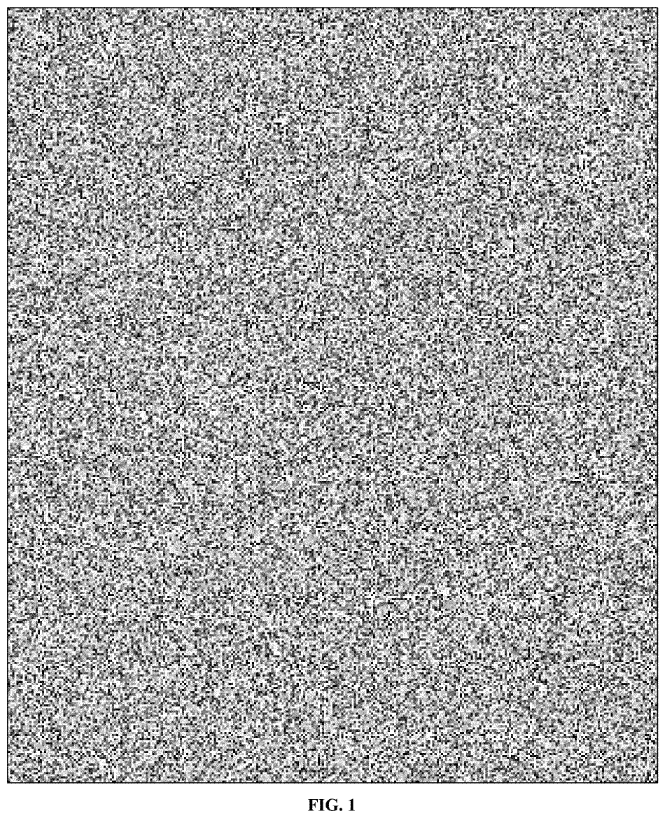

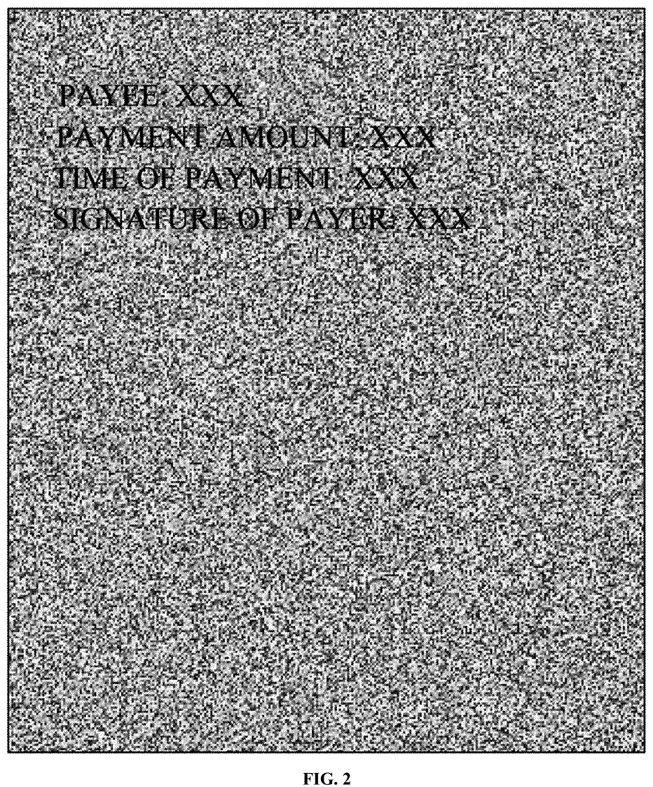

S1: The sender maps the pattern of the information to be encrypted on the first random scatter plot; the mapping is actually a virtual map, and its function is to form an area with the same shape as the pattern of the information to be encrypted on the first random scatter plot, which is called a local coverage area. The pattern of the information to be encrypted refers to the visual display image of the information to be encrypted. Taking the payment process as an application scenario, the first random scatter plot is shown in FIG. 1, and the encrypted information to be sent is the corresponding payment information, and its local coverage area is the text shown in the upper left corner of FIG. 2. Of course, the specific encrypted information can be changed according to the application scenario, and it can be other images that can represent information besides words. After obtaining the local coverage area, all the pixels or some randomly dispersed pixels in the local coverage area on the first random scatter plot are subjected to pixel value transformation to obtain the second random scatter plot.

It should be noted that in this step, the essence of pixel value transformation is to mark the position, and the marking method is to change the pixel value of the position on the first random scatter plot. During recognization by human eyes or machines, the information can still be captured with missing of some pixels, so all the pixels or some pixels may be selected for transformation. However, if some randomly dispersed pixels are selected in the local coverage area, the selection ratio should be such that the information can be read out after the pixels are subjected to display processing. For embodiment, supposing there is a word “one” in the information to be encrypted, and this word uses a very thick stroke, then the word “one” can only be replaced with a horizontal line thinner than the original word “one” or a dotted line. In addition, some pixels can also randomly selected in the original “one” area for pixel value transformation.

The unique identification code of the first random scatter plot and the second random scatter plot can be used as the carrier of encrypted information and transmitted to the receiver of the information. Because the second random scatter plot is a random map, people who are not aware of the scrambling process cannot tell the information on the map, and even if they know the information on the map, they don't know how to extract the information, which can fully guarantee the reliability of encryption.

S2: After receiving the unique identification code of the first random scatter plot and the second random scatter plot, the receiver can call the first random scatter plot stored by itself according to the received unique identification code, compare it with the received second random scatter plots pixel by pixel, and subject the pixels whose pixel values in the second random scatter plot are inconsistent with those in the first random scatter plot to display processing, so as to obtain the displayed encrypted information.

In this embodiment, the pixel value transformation method adopts the spatial scrambling method, and the specific process of the spatial scrambling method is: all pixels or some randomly dispersed pixels are selected in the local coverage area for spatial position exchange, and the image after spatial scrambling is still a random scatter plot.

Spatial scrambling in this embodiment refers to random scrambling of the spatial positions of pixels with pixel values unchanged, that is to say, performing random position exchange for the pixel distribution in space while keeping the pixel values unchanged, so that the image can be converted into a visual random scatter plot. This method can ensure that every pixel of the image can find a pixel with the same pixel value in the transformed image, and the anti-counterfeiting verification of the image can be carried out according to this characteristic. In this way, when the spatial position of a pixel is changed, only the spatial position but not the pixel value is changed. Therefore, after receiving the unique identification code of the first random scatter plot sent by the sender, the receiver calls the first random scatter plot stored by itself according to the unique identification code, and compares each pixel in the first random scatter plot with the received second random scatter plot to determine whether there is any pixel whose pixel value has been changed in addition to the change of the spatial position. If not, the anti-counterfeiting authentication passes, otherwise the anti-counterfeiting authentication does not pass. Here, there are many ways to determine whether the pixel value has been changed in addition to the exchange of the spatial position of the pixel. The simplest way is to sum the pixel values of all the pixels in each image, and then judge whether the sum of the pixel values of the two images is equal. If it is equal, the anti-counterfeiting authentication will pass, otherwise the anti-counterfeiting authentication will not pass. In addition, it is also possible to compare pixels point by point, that is, to process each pixel point by point from the first random scatter plot, to compare whether there is a pixel with the same pixel value in the second random scatter plot point by point, and if there is, the pixel is deleted from the second random scatter plot, and then the comparison of the next pixel is continued; if there is a certain pixel in the first random scatter plot, but no pixel with the same pixel value can be found in the second random scatter plot, it indicates that there is a difference in the image, and there may be tampering, and anti-counterfeiting authentication will not pass; otherwise, anti-counterfeiting authentication will pass.

In addition, in order to prevent possible leaks caused by using the same image many times, the sender and the receiver have a plurality of first random scatter plots, and each first random scatter plot has a unique identification code; before each pixel value transformation, a plurality of first random scatter plots are randomly selected to perform mathematical operation according to a predetermined rule, and a new first random scatter plot is generated to perform pixel value transformation; and the unique identification code of the first random scatter plot participating in the mathematical operation and the predetermined rule are sent to the receiver. Therefore, this method can make both parties know which first random scatter plot to use without transmitting the first random scatter plot, and at the same time, it can avoid leaking secrets.

In addition, different methods can be used to display different pixels, such as color display or other methods. The so-called color display is to uniformly mark such pixels as an easily recognizable color, while the so-called display by other methods only need to display the pixels, by pixel extraction, pixel mapping and the like for embodiment, to distinguish such pixels from other surrounding pixels and extract them into a blank image. Alternatively, the same pixels of the two images can be changed to 0 (blank), leaving the coverage area, that is, information.

### Embodiment 2

In this embodiment, compared with Embodiment 1, the difference is that the pixel value transformation method adopts a numerical value replacement method, and the numerical value replacement method is as below: all pixels or some randomly dispersed pixels are selected in the local coverage area, and their pixel values are directly replaced by other random values, and the image after numerical value replacement is still a random scattergram.

This method can also mark the pattern of the information to be encrypted invisibly, but because it changes the pixel values, the subsequent anti-counterfeiting verification is difficult. In this way, the anti-counterfeiting verification can distinguish the information that appears after the display processing, and determine whether there are pixels that are obviously not in the pattern area of the information to be encrypted. If there are, it can be regarded that the image has been tampered with.

In the following, the specific implementation process of the present disclosure will be described through several embodiments in combination with the application scenario of payment cognition, so that the skilled person can better understand the present disclosure.

Application Scenario:

1) Use object:

Sender A—User

Receiver B—Bank (or other intermediary lending institutions, such as a third-party payment platform)

2) Specific behavior: A wants to write a check or send a loan demand to bank B, and ask bank B to pay the other party, namely payee C.

3) Preparation: A goes to B, and at the same time, makes a first random scatter plot G₁ (here, taking the black-and-white image as an embodiment, but a color image is also applicable), so that both A and B hold this first random scatter plot G₁. (If it is a black-and-white image, it is a random scatter plot full of irregularities after scrambling, and if it is a color image, it is a colorful speckle map).

### Embodiment 1

A writes the payment information text on G₁ (including: the payment to someone or company, the amount of money, the shroff account number, the payment date and signature, and the specific payment information can be adjusted). The information is marked as L. The information can be written by typing, directly by keyboard, or manually. Then, the outline coverage area of the word is mapped on the original G₁ before the words are written, and the pixels in the coverage area are exchanged according to a certain rule or randomly. In the process of pixel interaction, the respective pixel values are not changed, but only the positions are adjusted. Or it only needs to change all the pixel positions in L (the part on G₁ with words) once in L coverage, which is equivalent to local scrambling in L. Therefore, G₁ is made into a new second random scatter plot G₁₀. G₁₀ and the unique ID number corresponding to G₁ are sent to B.

After obtaining G₁₀, the first random scatter plot G₁ stored by itself is retrieved according to the unique ID number corresponding to G₁. Then G₁₀ is compared with G₁ pixel by pixel, and points with different pixel values (such as gray values) are marked in red. In this way, a red text will appear in G₁₀, and B can see the payment information and requirements of A, and then pay the money to C.

Of course, before payment, anti-counterfeiting authentication can also be carried out. The specific anti-counterfeiting authentication method is as described above, that is, whether there is any pixel whose pixel value has been changed in addition to the exchange of spatial position.

### Embodiment 2

In this application, another method can also be used to transform the pixel values in the outline coverage area of L, that is, all the pixels in the outline coverage area of L are removed, and then some new random pixel values are added, so that random points are added to each pixel in the area of L. After adding the random points, it is necessary to ensure that there is no trace of the change of the L area in the whole G₁₀ image. G₁₀ is sent to B. However, a disadvantage of this method is that all the original pixel values in the L area are lost, which makes it difficult to anti-counterfeiting verification. However, this method can also be applied to common cases with low safety requirements.

### Embodiment 3

On the basis of the preceding two embodiments, this embodiment further proposes a dynamic synchronous random change method of the image G₁.

The weakest link of the method of the application is that G₁ may be stolen, so the image G₁ must be randomly changed in a dynamic way. Requirements for a dynamic change law are: 1) the change law should be simple, can be realized on mobile phones, and complete the whole process in a few seconds; 2) G₁ is not transmitted, but the other party can know the changed G₁ (at the same time, the same G₁ can be generated); 3) The less requirements for the correlation with G₁ used several times before, the better, so that people cannot find the change law. The only thing that can be transmitted in transmission is the parameters of the transformation law. Specific embodiments are as follows:

1) Each party has dozens or hundreds (or more) of G₁ images, and the images are marked with unique identification codes, such as unique number ID. Both parties should only know the number of the image during use, and the number can be transmitted online. Since both the parties know the number, they can use the same G₁ to realize G₁ synchronization.

2) Any two of dozens or hundreds of G₁ images in 1) are superimposed to become a new G₁. It only needs to pass the numbers of the two selected images to each other during use, so that the other party can get the same superimposed image G1 (of course, three or more images can be superimposed, and the superposition rule can be arbitrary). This means that several times to dozens of times of G₁ images are added for both A and B.

3) One G₁ image is divided into several areas, and the pixels of two areas are arbitrarily taken for “rough scrambling”. The above process is repeated until the whole G₁ area has been replaced. The process transformation rule is sent to B synchronously, so that the other party can get the same transformed image G₁.

4) The above methods can be mixed together, and other transformation methods can be used, as long as the same G₁ can be generated for both parties of A and B while no scrambled image G₁ is transmitted between the two parties.

The above embodiments and applications can be implemented on mobile devices, for embodiment, pixel value transformation, spatial scrambling, pixel value comparison and the like can all be implemented by algorithms. Of course, they can also be assisted by manual intervention, which is not limited. In the above applications, at the sender A, the text can be input from other systems (including two-dimensional bar code input, etc.) on the mobile phones. If it is used in the Alipay system, the original mobile phone operation process can be almost completely retained. In addition, operations such as signature can be added when necessary (this can be added or not according to the importance of information). The whole random image transformation does not need to be displayed on the screen at all, and the original operations are basically kept and the change of user's operation habits re minimized as much as possible.

In the above embodiments and applications, all the images involved can be color images or gray images, as long as they are consistent. That is to say, this method can be used in black-and-white images, and it can also be used in color images, but the gray value is changed to a color pixel value. In addition, the pixel value of the image can be 8-bit, 24-bit or other bits, or images of other bits can be used.

In the above embodiments and applications, the so-called encrypted information can be characters, patterns such as two-dimensional codes and bar codes, or other pictographic elements, as long as both parties can recognize their meanings. In addition, the writing process of information on the image can be input by keyboard, or by handwriting, or from other systems.

In the above embodiments and applications, in the random scatter plot, the local coverage area is composed of characters and graphs with information, and the location, size and shape of the local coverage area can be arbitrary. In the above applications, although the method of partially changing the pixel value in the local coverage area is given, in fact, other ways can also achieve this function. Specifically, the pixel values of the pixels in the local coverage area can be changed in the following four ways:

1) Pixels in the coverage area are randomly scrambled; after scrambling, it is still a random scatter plot, and there is no difference between the coverage area and other areas of the scatter plot.

2) All pixels in the coverage area are removed, and random noise is added in the coverage area to form a new random scatter plot; it also makes it impossible to distinguish the difference between the coverage area and other areas.

3) A part of the scatter plot (for embodiment, the top rows of pixels are taken; the bottom rows of pixels or the left and right sides of the image are taken; or the pixels in the corner image area of the map are taken, and the corner of the image can be triangular, rectangular or other shapes) are exchanged (or replaced) with the pixels in the coverage area.

4) The pixels in the coverage area are removed, and the pixel values in a part of the scatter plot are copied as random numbers to fill the coverage area.

The above four methods are all methods of changing the pixel values in the local coverage area, and they can be selected arbitrarily in actual operations without any restrictions.

The steps of the method or algorithm described combined with the embodiments of the present disclosure may be implemented in a hardware manner, or may be implemented in a manner in which a processor executes software instructions. The software instructions may consist of corresponding software modules, and the software modules can be stored in Random Access Memory (RAM), flash memory, Read Only Memory (ROM), Erasable Programmable ROM (EPROM), Electrically Erasable Programmable Read-Only Memory (EEPROM), registers, hard disks, removable hard disks, CD-ROMs or any other forms of storage media well-known in the art. An exemplary storage medium is coupled to the processor, such that the processor can read information from, and write information to, the storage medium. The storage medium can also be an integral part of the processor. The processor and storage medium may reside in an Application Specific Integrated Circuit (ASIC). Alternatively, the ASIC may be located in a node device, such as the processing node described above. In addition, the processor and storage medium may also exist in the node device as discrete components.

It should be noted that when the data compression apparatus provided in the foregoing embodiment performs data compression, division into the foregoing functional modules is used only as an example for description. In an actual application, the foregoing functions can be allocated to and implemented by different functional modules based on a requirement, that is, an inner structure of the apparatus is divided into different functional modules, to implement all or some of the functions described above. For details about a specific implementation process, refer to the method embodiment. Details are not described herein again.

All or some of the foregoing embodiments may be implemented by using software, hardware, firmware, or any combination thereof. When the software is used for implementation, all or some of the embodiments may be implemented in a form of a computer program product. The computer program product includes one or more computer instructions. When the computer program instructions are loaded and executed on a server or a terminal, all or some of the procedures or functions according to the embodiments of this application are generated. The computer instructions may be stored in a computer-readable storage medium or may be transmitted from a computer-readable storage medium to another computer-readable storage medium. For example, the computer instructions may be transmitted from a web site, computer, server, or data center to another web site, computer, server, or data center in a wired (for example, a coaxial optical cable, an optical fiber, or a digital subscriber line) or wireless (for example, infrared, radio, or microwave) manner. The computer-readable storage medium may be any usable medium accessible by a server or a terminal, or a data storage device, such as a server or a data center, integrating one or more usable media. The usable medium may be a magnetic medium (for example, a floppy disk, a hard disk, or a magnetic tape), an optical medium (for example, a digital video disk (DVD)), or a semiconductor medium (for example, a solid-state drive).

The above embodiments are only a preferred solution of the present disclosure, but it is not intended to limit the present disclosure. Those of ordinary skill in the relevant technical field can make various changes and modifications without departing from the spirit and scope of the present disclosure. Therefore, all technical solutions obtained by equivalent substitution or equivalent transformation fall within the scope of protection of the present disclosure.

What is claimed is:

1. An anti-counterfeiting and encryption method based on a local random image transformation technique, wherein both a sender and a receiver of encrypted information have a same first random scatter plot; the anti-counterfeiting and encryption method comprises the following steps:
S1, forming, by the sender, a corresponding local coverage area on the first random scatter plot with a pattern of information to be encrypted, and carrying out pixel value transformation on all pixels or some randomly dispersed pixels in the local coverage area on the first random scatter plot to obtain a second random scatter plot;
S2, after receiving a unique identification code of the first random scatter plot and the second random scatter plot, calling, by the receiver, the first random scatter plot stored by the receiver according to the unique identification code, comparing the first random scatter plot with the received second random scatter plot point by point, and subjecting the pixels in the second random scatter plot whose pixel values are inconsistent with those in the first random scatter plot to display processing to obtain displayed encrypted information.

2. The anti-counterfeiting and encryption method based on a local random image transformation technique according to claim 1, wherein a method for the pixel value transformation adopts a spatial scrambling method, and the spatial scrambling method comprises the following steps: selecting all pixels or some randomly dispersed pixels in the local coverage area, and performing spatial position exchange, so that an image after spatial scrambling is still a random scatter plot.

3. The anti-counterfeiting and encryption method based on a local random image transformation technique according to claim 2, wherein in the spatial scrambling method, when the spatial positions of pixels are exchanged, only the spatial positions rather than pixel values are changed; after receiving the unique identification code of the first random scatter plot sent by the sender, the receiver calls the first random scatter plot stored by itself according to the unique identification code, compares each pixel in the first random scatter plot with the received second random scatter plot, and determines whether there is any pixel whose pixel value has been changed in addition to exchange of the space position; if there is no pixel whose pixel value has been changed in addition to exchange of the space position, anti-counterfeiting authentication passes, and if there is any pixel whose pixel value has been changed in addition to exchange of the space position, the anti-counterfeiting authentication does not pass.

4. The anti-counterfeiting and encryption method based on a local random image transformation technique according to claim 1, wherein the method for the pixel value transformation adopts a numerical value replacement method, and the numerical value replacement method comprises the following steps: selecting all pixels or some randomly dispersed pixels in the local coverage area, and replacing the pixel values thereof directly by another random values, so that the image after numerical value replacement is still a random scatter plot.

5. The anti-counterfeiting and encryption method based on a local random image transformation technique according to claim 2, wherein when selecting randomly dispersed part of pixels in the local coverage area, a selection ratio is configured to be capable of reading information after the part of pixels are subjected to display processing.

6. The anti-counterfeiting and encryption method based on a local random image transformation technique according to claim 1, wherein the information to be encrypted is characters or patterns with information.

7. The anti-counterfeiting and encryption method based on a local random image transformation technique according to claim 1, wherein there are a plurality of first random scatter plots, and each of the first random scatter plots has a unique identification code; the receiver stores a gallery containing the plurality of first random scatter plots; before each pixel value transformation, several first random scatter plots are randomly selected to perform a mathematical operation according to a predetermined rule, and a new first random scatter plot is generated to perform the pixel value transformation; and the unique identification code of the first random scatter plot participating in the mathematical operation and the predetermined rule are sent to the receiver.

8. The anti-counterfeiting and encryption method based on a local random image transformation technique according to claim 1, wherein the display processing is color display or display with other methods.

9. The anti-counterfeiting and encryption method based on a local random image transformation technique according to claim 1, wherein the image is a black-and-white image or a color image.

10. The anti-counterfeiting and encryption method based on a local random image transformation technique according to claim 1, wherein the pixel value of the image is 8 bits, 24 bits or other bits.
